(19) United States
(12) Patent Application Publication
(10) Pub. No.: US 2015/0122017 A1
(43) Pub. Date: May 7, 2015

(54) CHROMOGENIC HUMIDITY SENSOR

(71) Applicant: POSTECH ACADEMY-INDUSTRY FOUNDATION, Pohang-si (KR)

(72) Inventors: Moon Jeong Park, Pohang-si (KR); Eunyoung Kim, Incheon (KR)

(21) Appl. No.: 14/400,330

(22) PCT Filed: May 6, 2013
(86) PCT No.: PCT/KR2013/003890

§ 371 Date: Nov. 10, 2014

(30) Foreign Application Priority Data
May 11, 2012 (KR) 10-2012-0049975

(51) Int. Cl. G01N 21/81

(52) U.S. Cl. CPC G01N 21/81
USPC 73/335.01

(57) ABSTRACT

The present invention relates to a humidity sensor, and more particularly, to a resistance film-type real-time chromogenic humidity sensor produced with a polyelectrolyte thin film. The humidity sensor according to the present invention is a chromogenic hygrometer in which a polyelectrolyte nano thin film that absorbs moisture is formed on a reflective layer, and the nano thin film varies terms of color and electrical resistance as moisture is absorbed and the thickness varies. The hygrometer according to the present invention is a dual-function hygrometer, the color and resistance of which vary. Provided is the chromogenic hygrometer in which the sensor made using a PSS-b-PMB thin film varies in color between purple, blue, green, yellow, orange, and red according to humidity at a very high response speed of within one minute.

### TECHNICAL FIELD

The present invention relates to a humidity sensor. More particularly, the present invention relates to a real-time, colorimetric resistive-type humidity sensor made of a polymeric electrolyte thin film.

### BACKGROUND ART

Chemical sensors based on stimuli-responsive materials have been extensively investigated in past decades. Among a wide variety of target molecules, the accurate and reliable measuring of humidity has attracted great attention in diverse fields including medical science, the food industry, and electronic applications.

Different types of humidity sensors have been developed from porous ceramics, metals, and polymeric materials, and materials used in these sensors exhibit changes in physical properties such as capacity, resistance, surface acoustic wave, reflection, and fluorescent emission, upon exposure to moisture.

In the class of humidity-sensitive materials, polymeric materials have particular advantages of flexibility, easy fabrication, and low cost. Especially, polymer electrolytes have been the most widely exploited polymeric materials as resistive-type humidity sensors owing to their ion-conducting characteristics. For polymer electrolytes, polymer-salt complexes, and hydrophilic vinyl polymers bearing acid groups or quaternary salts have been commonly used.

Several approaches are in progress to tailor the physicochemical properties of polymer electrolytes toward high performance humidity sensors. For example, in an effort to achieve high sensitivity and fast response, the incorporation of hygroscopic ingredients, that is, acid and nanoparticles, into the polymer electrolytes has been carried out. However, the blending often results in sensor drift and poor durability under repeated hydration/dehydration cycles.

Along with the chemical constituents, interestingly, it has been revealed that structural aspects are also important parameters in attaining improved sensor performance under differing levels of humidity. The widespread use of photonic crystals in humidity sensors is a good example of the structural design of polymer electrolytes.

Photonic crystals exhibit unique structural colors, which can be altered by water absorption, if accompanied by significant changes in lattice spacing. This color change leads to a visually readable response under indoor illumination, which can simplify sensor devices by eliminating the need for analytical instruments to measure the signals. Although the photonic crystals have shown promise, large volume changes over a several-fold are essentially required for the recognition of color changes with the naked eye, impeding fast response time and good reversibility of the sensors. Further, since the fabrication of most photonic crystals depends indispensably on the condition of colloidal particles, it is difficult to produce photonic crystals on mass scale at low cost.

Accordingly, there is a continuation of the need for polymer-based humidity sensors with both fast responsiveness and high sensitivity.

### DISCLOSURE

### Technical Problem

It is an object of the present invention to provide a polymeric humidity sensor with fast responsiveness and high sensitivity.

It is another object of the present invention to provide a method for measuring humidity on the basis of a polymer that is quickly responsive and highly sensitive to humidity.

It is a further object of the present invention to provide a method for measuring humidity through a visibly recognizable color change.

It is still another object of the present invention to provide a method for measuring humidity through a visibly recognizable change in color and resistivity.

### Technical Solution

In order to accomplish the above objects, the present invention provides a colorimetric sensor, comprising a nano-film capable of absorbing a measurement target, formed on a reflection layer wherein the nano-film changes in color as its thickness changes with the absorption of the measurement target. In this context, the colorimetric sensor may be used as a hygrometer as the nano-film formed on the reflection layer changes in thickness with the absorption of moisture.

As used herein, the term “nano-film” is defined as a film that is as thin as 1-1000 nanometers.

As used herein, the term “color change” means a shift in the wavelength of reflection light. In this regard, the term color change is understood to mean that the wavelength of reflection light is shifted to cause a color change recognizable with the naked eye.

The term “reflection” is understood herein as a change in direction of a wavefront, preferably with a reflectance of 70% or higher, more preferably, 80% or higher, even more preferably 85% or higher, and most preferably 90% or higher.

As used herein, “strong electrolyte” refers to a substance that ionizes with a high degree of dissociation (pKa <3) when dissolved in water.

In context with the measurement target, the nano-film may be selected from among various thin films that can absorb the target. For humidity, for example, the nano-film may be a hydrophilic thin film that can absorb water. For use in measuring an alcohol content in air, the nano-film should be able to absorb alcohol.

Without being bound by or limited to theory, the color change with thickness of the sensor according to the present invention, as illustrated in the following Scheme 1, is understood to be based on the fact that a film with a hydrogscopic nature swells in the presence of moisture and changes in thickness and refractive index, causing alteration in the wavelength of visible light reflected thereby.

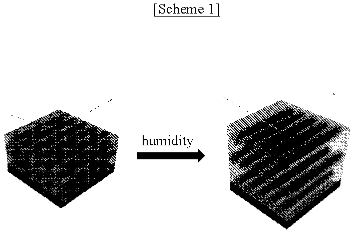

Scheme 1 is a schematic illustration of the structure of the PSS-b-PMB humidity sensor and the mechanism of the color changes between low and high RH conditions. The hygroscopic PSS chains spontaneously absorb water from moist air and the swelling changes the film thickness to reflect visible light with different wavelengths.

In the present invention, the nano-film may be formed preferably to have a thickness of 10 nm˜400 nm. A film with a thickness of 10 nm or less is difficult to form by coating. On the other hand, the reflection light from a film thicker than 400 nm is out of the visible spectrum, thus displaying no visible colors.

The nano-film according to the present invention reflects wavelengths in the visible light range, thus displaying the visibly recognizable colors, that is, violet, cyan, blue, green, yellow, orange or red.

In one embodiment of the present invention, the nano-film changes in color toward longer wavelengths while thickening with the absorption of the measurement target. For example, the nano-film displaying violet in a dried state turns to blue, green, yellow, orange and red in progression when it becomes thicker with the absorption of moisture.

In another embodiment of the present invention, the reflection layer on which the nano-film is formed may be a light reflecting substrate, e.g., a silicon wafer or a mirror.

So long as it reflects light, any material may be used to form the reflection layer. It may be formed on various surfaces, such as those of metal, silicon wafers, mirrors, etc.

In another embodiment of the present invention, the measurement target is an entity contained in gas that is not absorbed by the nano-film or that does not cause the nano-film to undergo a change in thickness even though absorbed to the nano-film. By way of example, it may be moisture in air.

In another embodiment of the present invention, the nano-film changes in thickness preferably by up to 200%. If the nano-film thickens too much when absorbing a measurement target, the wavelength of the reflection light may extend to the infrared region. Further, when the thickness fluctuates too much, the nano-film cannot endure repetitive thickness changes.

In another embodiment of the present invention, the nano-film changes in reflectance index as well as in thickness to alter wavelengths of the reflection light.

In accordance with another aspect thereof, the present invention provides a chromogenic hygrometer, comprising an electrolyte polymer nano-film capable of absorbing a measurement target, formed on a reflection layer, wherein the nano-film changes in color and electrical resistivity as its thickness changes with the absorption of the measurement target.

In one embodiment of the present invention, the polymer nano-film formed on the reflection layer changes in thickness with the absorption of water thereto, which makes the light reflected from the nano-film longer in wavelength and which thus leads to a color change. Moreover, when absorbing water, the nano-film changes in conductivity and thus has an altered electrical property, e.g., resistance.

As used herein, the term “electrolyte polymer” refers to a polymer that undergoes electrolysis upon water absorption. So long as it contains a functional group that is electrolysed by water absorbed thereto, any polymer may be employed in the present invention. In an embodiment of the present invention, the electrolyte polymer may preferably contain a strong electrolyte functional group, such as a sulfone group, which can amplify a change in resistance upon water absorption.

According to one embodiment of the present invention, the electrolyte polymer may be a homopolymer, a copolymer, or a block copolymer. By way of example, a sulfone-containing polymer may be a block copolymer composed of a sulfonated polystyrene block and a hydrophobic block, or a sulfonated polystyrene homopolymers. The sulfonated polystyrene block is a polystyrene moiety where —H on the benzene ring is substituted by SO₃H, with a sulfonation level adjusted within 10-90%. A versatile spectrum of hydrophobic blocks may be employed. For example, a polyalkylbutylene block, e.g., polymethylbutylene block, may be available.

In another embodiment of the present invention, the electrolyte polymer is structured to have a hydrophilic polymer matrix in which hydrophobic polymer domains are dispersed. In this morphology, the hydrophilic polymer matrix plays a role in improving responsiveness to humidity change while the hydrophobic polymer domains imparts the polymer film with durability against repetitive volumetric changes. According to one embodiment of the present invention, the electrolyte polymer may be preferably a block copolymer in which the hydrophobic polymer domains are regularly arranged with the hydrophilic matrix by self assembly.

In another embodiment of the present invention, the electrolyte polymer is a block copolymer composed of a sulfonated polystyrene block and a polyalkylbutylene block, e.g., polymethylbutylene block, wherein cylindrical polymethylbutylene blocks are dispersed in an ordered fashion within the sulfonated polystyrene matrix.

In accordance with a further aspect thereof, the present invention provides a method for measuring humidity, using a hygrometer comprising an electrolyte polymer nano-film formed on a light-reflecting layer wherein the nano-film changes in color as its thickness varies with the absorption of moisture thereto. The color change may be observed simply with the naked eye or may be measured using a UV-VIS reflectometer.

In accordance with still another aspect thereof, the present invention provides a thin film, composed of a polystyrene-polyalkylbutylene block copolymer, where cylindrical polyalkylbutylene blocks are arranged in an ordered fashion within the solfonated polystyrene matrix.

### Advantageous Effects

According to the present invention, a hygrometer that changes in color and resistivity with humidity and a method for preparing the same are provided.

Particularly, a sensor made of PSS-b-PMB film can variously change in color from violet to blue, green, yellow, orange and red, or vice versa within one minute depending on humidity, and thus can be used as a colorimetric hygrometer. Further, the colorimetric hygrometer undergoes a considerable change in resistance depending on humidity owing to its strong electrolyte polymer.

The hygrometer according to the present invention is a polymer thin film sensor that can visually and electrochemically respond to humidity, and finds applications in various microsensors.

### DESCRIPTION OF DRAWINGS

FIG. 1 shows a molecular structure of poly(styrenesulfonate-bmethylbutylene) (PSS-b-PMB) copolymers (a), and cross-sectional TEM images of P(60) sample representing hexagonally packed hydrophobic PMB cylinders, dispersed in a hydrophilic PSS matrix (b). The PSS domain was darkened by RuO₄ staining and the scale bars represent 100 nm.

FIG. 2 shows UV-visible reflectance spectra of (a) P(35), (b) P(60), and (c) P(76) thin films with qualitatively the same thickness of ˜240 nm under RH=20% and RH=90% conditions. At an RH of 90%, P(35), P(60), and P(76) films swell to reflect a peak wavelength of 457 nm (blue), 523 nm (green), and 590 nm (orange), respectively. The whole shift of the reflectance wavelength is marked in each panel. The inset photographs in panel a are obtained at an RH of 20% (violet) and 90% (blue), while those in panels b and c are taken at an RH of 90%.

FIG. 3 is a 3-dimensional phase cube of PSS-b-PMB sensors as a function of relative humidity (RH) and sulfonation level (SL). The z-axis indicates water uptakes to illustrate the degree of swelling of each sensor. Filled symbols represent experimental data while the 3D color surface within the cube was obtained using a Renka-Cline gridding algorithm. Cross-sectional 2D color diagrams at SL=76 mol % and RH=95% are given in the right-hand side of the cube.

FIG. 4 shows UV reflectance profiles at an RH of 90% for P(60) and P(76) films, fitted by Macleod™ package. Refractive index (n) and film thickness (d) are employed as fitting parameters.

FIG. 5 shows GISAXS intensities of a P(60) film at (a) RH=20% and (b) RH=90% conditions as a function of the scattering vectors along the horizontal and vertical direction. Upon exposing the P(60) film to RH=90%, an intriguing distortion of hexagonal symmetry in the 2D scattering pattern is revealed, as illustrated in the inset graphics of (b).

FIG. 6 shows impedance changes of a P(76) film, monitored with repeated stepwise changes in RHs, as indicated by inverted arrows (a), and data on the sensitivity defined as ΔR/R₀ (ΔR: resistance change, R₀: initial resistance value) during hydration and dehydration of two sets of P(29) and P(76) films (b).

### BEST MODE

A better understanding of the present invention may be obtained through the following embodiments that are set forth to illustrate, but are not to be construed as limiting the present invention.

Synthesis of PSS-b-PMB Copolymers

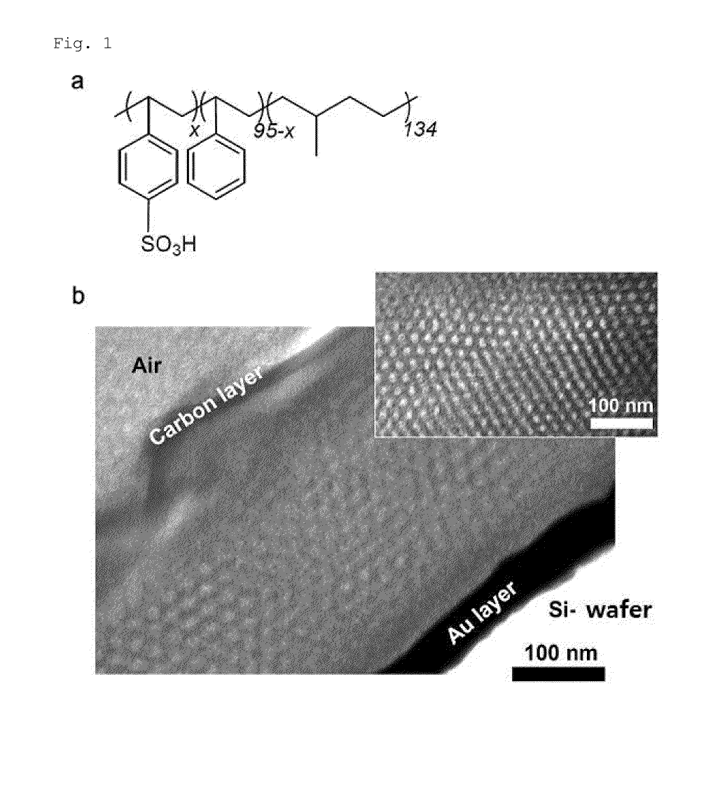

A set of PSS-b-PMB copolymers with different sulfonation levels (SLs) was prepared according to the procedures in document [44] M. J. Park, K. H. Downing, A. Jackson, E. D. Gomez, A. M. Minor, D. Cookson, A. Z. Weber, N. P. Balsara, Nano Lett. 2007, 7(11), 3547, document [45] S. Y. Kim, M. J. Park, N. P. Balsara, A. Jackson, Macromolecules, 2010, 43 (19), 8128, and document [46] S. Y. Kim, S. Kim, M. J. Park, Nat. Commun. 2010, 1, 88. , which are all hereby incorporated by reference in their entireties into this application. A poly(styrene-b-isoprene) (PSb- PI,9.5-9.1 kg/mol, polydispersity index of 1.02) precursor block copolymer was synthesized by sequential anionic polymerization of styrene and isoprene. The molecular weight and molecular weight distribution of PS-b-PI were characterized by combining ¹H Nuclear Magnetic Resonance (NMR, Bruker AVB-300) spectroscopy and gel permeation chromatography (GPC, Waters Breeze 2 HPLC). The saturation of PI chains was performed in the presence of a homogeneous Ni—Al catalyst at 80° C. and 420 psi, followed by the sulfonation reaction of PS blocks. Six different SL values of 29, 35, 42, 49, 60, and 76 mol. % were obtained by controlling sulfonation reaction times where the SL values were calculated by the ratio of moles of sulfonated styrene (after the reaction) to total moles of styrene (before the reaction). The molecular structure of resulting materials is shown in FIG. 1a where the subscripts indicate the degree of polymerization of each block. For brevity, the samples are labeled only with the SL values. For example, P(35) indicates the PSS-b-PMB copolymer with 95 PS chains and 134 PMB units where 35 mol. % of PS chains (ca. 33 units) is sulfonated. The SL values were controlled from 29 to 76 mol % to adjust the hygroscopic properties. The ability to control the SL values would give benefits in optimizing sensor performance. The incorporation of hydrophobic PMB chains is expected to restrain excessive swelling of the films upon exposure to water vapor. In particular, the thermodynamic immiscibility between PSS and PMB chains can create self-assembled morphology, and this PSS matrix offers short water diffusion pathways in nanometer scales for hydration and dehydration.

Fabrication of PSS-b-PMB Hygrometer:

Anhydrous tetrahydrofuran (THF,=99.9%) free of inhibitors was used without purification. The PSS-b-PMB copolymers P(22), P(35), P(42), P(49), P(60), and P(76) with predetermined weights were placed in respective glass vials, and prepared as 4 wt % solutions in THF. Each solution was stirred overnight at room temperature, and spin-coated on a Si wafer with a native oxide layer. The films thus formed were dried at room temperature for 5 days in a vacuum over. As a result, colorimetric hygrometers respectively comprising P(22), P(35), P(42), P(49), P(60), and P(76) on Si wafers, each 240 nm thick, were fabricated.

TEM Image of Thin Film

The morphology of the films beneath the surface in position space was investigated by cross-sectional transmission electron microscope (TEM) experiments. The standard technique of delaminating polymer films using an epoxy matrix was employed. TEM images demonstrate that the films have well defined hexagonal cylindrical morphology (HEX) possessing hydrophobic PMB cylinders, dispersed in a hydrophilic PSS matrix. The equilibrium morphology that is obtained in bulk phase is analogous to the thin film morphology with negligible difference in domain size, as shown in the inset of FIG. 1b. Noted here is that all of the PSS-b-PMB samples examined in present invention exhibit qualitatively the same HEX morphologies, with average domain spacings of 21.6±2.9 nm. This is in sharp contrast to other block copolymer humidity sensors where parallel-oriented lamellae were employed.

Color Display of PSS-b-PMB Films upon Exposure to Humidity

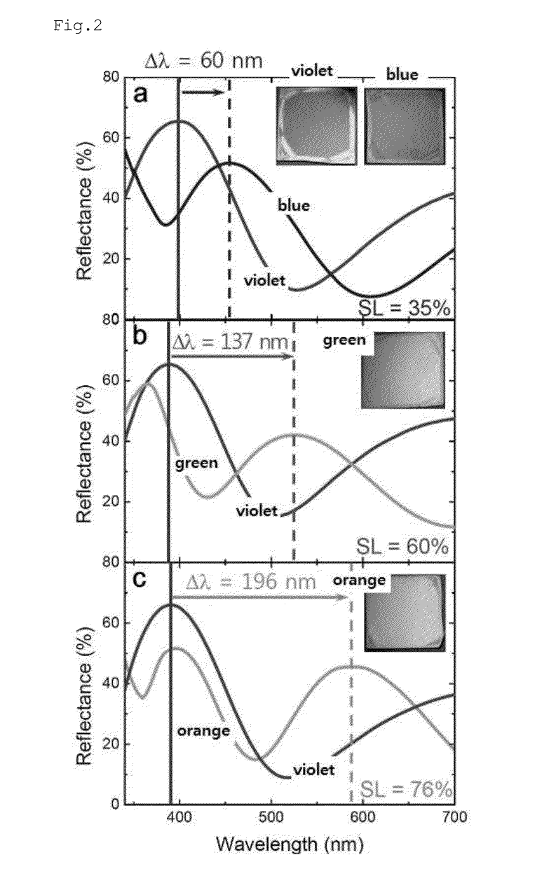

The P(22), P(35), P(42), P(49), P(60), and P(76) PSS-b-PMB films with thickness of ca. 240 nm were placed in a benchtop humidity temperature environmental chamber (JEIO Tech, TH-PE-025) where the temperature was set at room temperature. The changes in reflective color under levels of humidity upon switching relative humidity from 20 to 90% were monitored in real-time via specially designed transparent window. The impedance of the PSS-b-PMB films at each humidity condition was simultaneously measured using a 1260 Solatron impedance analyzer. For the impedance measurements, interdigitated gold stripes were employed as working and counter electrodes to apply a current to the films where the gold stripes were 300 μm wide and 300 μm apart from each other. Data was obtained at a frequency range of 1˜100,000 Hz. Color results of P(35), P(60), and P(76) are depicted in FIG. 2.

In a vacuum state with an RH of up to 30% maintained, all samples indicate a violet reflection color. However, exposing dry films to moist air resulted in visually readable instant color changes, as identified by the naked-eye and UV reflectance experiments.

The UV reflectance of P(35) indicates red shift in the wavelength from 397 nm (violet, RH=20%) to 457 nm (blue, RH=90%) upon a change of RH from 20 to 90%. Photographs of the P(35) film taken at an RH of 20% (violet) and 90% (blue) are shown in the inset of FIG. 2a. When the same experimental protocols are repeated with P(60) and P(76) samples of violet color, the reflection colors at RH=90% were deviated as green and orange, respectively. The red shift values of reflection wavelengths P(60) and P(76) films were 137 and 196 nm, respectively. In FIGS. 2b and 2c, the UV reflectance profiles of P(60) and P(76) at RH=90% are plotted, compared to those at an RH of 20%. The insets of FIGS. 2b and 2c show reflection colors at an RH of 90%.

Water Uptake Measurements:

P(22), P(35), P(42), P(49), P(60), and P(76) were prepared into respective 5 μm thick freestanding films which were then evaluated for equilibrium water uptake. Polymer films with a thickness of 5 μm were prepared by solvent casting from 1 wt % THF solutions. The films were dried at room temperature for 3 days under a N₂ blanket and at 50° C. for 5 days under a vacuum. The films were located in a benchtop humidity/temperature environmental chamber (JEIO Tech, TH-PE-025). The amounts of water absorption at given relative humidities (RHs) were measured using a Mettler balance with 0.01 mg accuracy. The water uptake is calculated according to the following formula:

water uptake (%)=((weight of wet film−weight of dry film)/weight of dry film)×100 (1)

At an RH of 90%, the water uptake of P(35), P(60), and P(76) films were observed to be 27wt %, 45wt %, and 58wt %, respectively, at a room temperature.

### Mode for Invention

3D RGB Diagrams of PSS-b-PMB Sensors Under Different Humidities

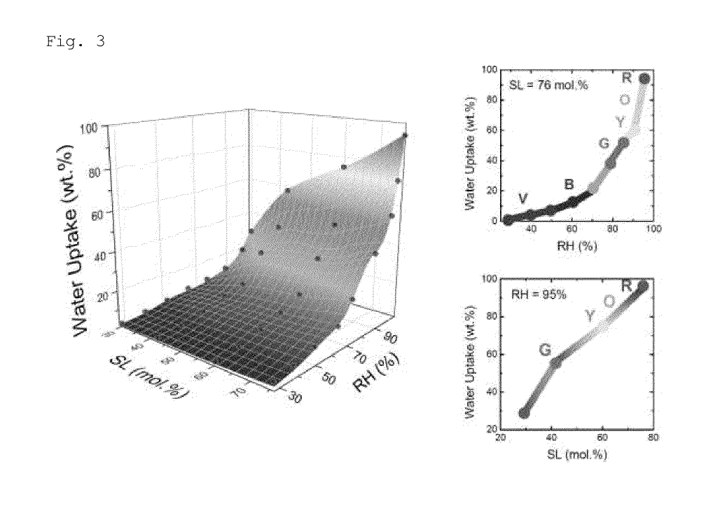

At different RHs, the PSS-b-PMB films with different sulfonation levels exhibit characteristic reflection colors, which are plotted inside the 3D cube in FIG. 3. The z-axis shows equilibrium water uptake values of 5 μm thick freestanding films while the sulfonation levels of 240 nm thick PSS-b-PMB films and relative humidities are represented on x-and y-axis, respectively. Filled symbols in the 3D cube represent experimental data while the 3D color surface within the cube was obtained using a Renka-Cline gridding algorithm, which is part of the OriginPro 8.5(R) software package.

As can be seen in left-front portions of the cube, the PSS-b-PMB films in a dry condition at an RH of 30% appear violet, and undergo a color change with an increase in RH. The thin films with relatively low sulfonation levels change in color from violet to blue while a considerable window of color diagram is occupied by green/yellow colors for highly sulfonated samples. As shown in FIG. 3, P(76) sample can cover the almost entire visible spectrum from violet to red with RHs ranging from 30 to 95%.

Relation Between Water Uptake and Color

Even though having different sulfonation levels, the PSS-b-PMB film samples were observed to take the same color when they exhibited similar levels of water uptake. The water uptakes of 17 wt % at an RH of 90% by P(29), 25 wt % at an RH of 80% by P(42), and 22 wt % at an RH of 75% by P(76) yield qualitatively the same blue-green color. The P(42), P(60), and P(76) samples exhibited water uptakes of 55wt %, 49wt %, and 50wt % at RH=95%, 90%, and 85%, respectively, all taking the same green color.

Color Sensitivity of Films with Various Sulfonation Levels

2D RGB diagrams accounting for the 3D diagram are provided as lower panels of the 3D cube of FIG. 3. In the figure, the letters R, O, Y, G, B and V stand for red, orange, yellow, green, blue, and violet, respectively. For example, referring to a 2D diagram corresponding to the cross-section of the cube at a sulfonation level of 76 mol % (side view of the cube), colors taken by the P(76) sample are displayed according to relative humidity. The other 2D diagram exhibits reflection colors of the PSS-b-PMB sensor at an RH of 95% according to sulfonation level under a saturated water vapor. Like P(60) and P(76), samples with high sulfonation levels exhibit high sensitivity when reading humidity values. For example, the P(6) film turned from green to yellow upon a RH change from 90% to 92%, and its color was further shifted to orange upon exposure to RH 96%. Likewise, the P(76) films displayed a serial color change from green at RH 85% to yellow at RH 88%, orange at RH 90%, and red at RH 95%.

Target Relative Humidity According to Film Thickness

The color of the films at a target relative humidity can be controlled by adjusting the thickness thereof. For example, a 340 nm-thick P(76) film appearing green in a dry state displayed a yellow color at RH 40%, an orange color at RH 50%, and a red color at RH 60%.

Colorimetric Responsiveness of the Films to Humidity Change

For all samples, color changes were observed within one minute (actually, within a few seconds) irrespective of RH fluctuations. Colors were maintained stably even when the films were exposed for up to one day. Color changes during dehydration were conducted in the same manner as those during hydration, but in a reverse mode. When completely dehydrated, the films exhibited a blue shift at a rate of as fast as in min or less.

On the P(60) film, fast and reproducible color changes among blue-violet at RH 30%, cyan at RH 80%, and yellow-green at RH 90% were demonstrated.

Change in Film Thickness and Refractive Index with Humidity

When exposed to humid air, the films were examined for change in film thickness (d) and refractive index (n) for model fits with a single layer model, using Macleod™ package, as confirmed by real-time GISAXS experiments.

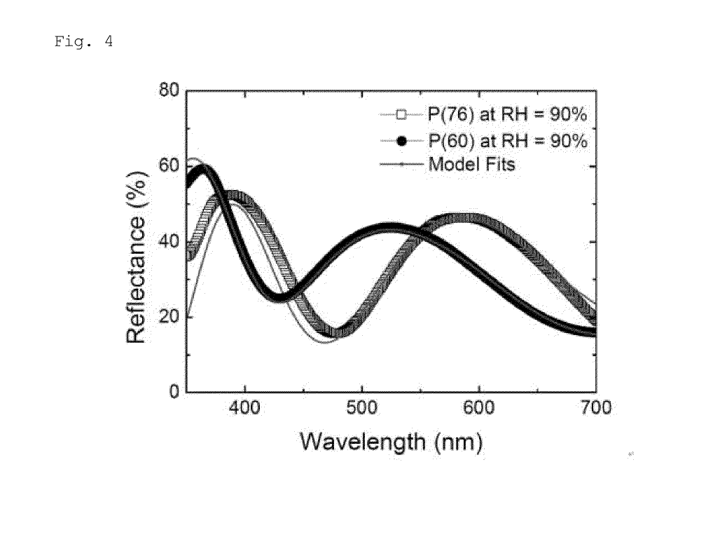

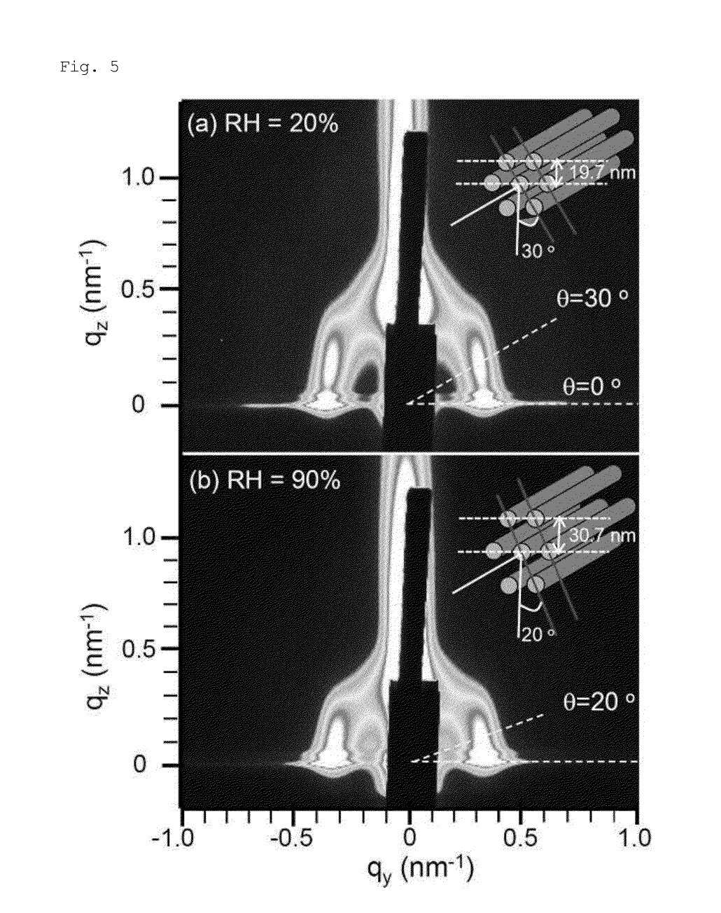

Fitting results of UV reflectance profiles of P(90) and P(76) films at RH 90% are depicted in FIG. 4. In FIGS. 5a and 5b, GISAXS intensities of the P(60) film before and after exposure to RH 90% at room temperature are given.

The model fits suggest that n=1.47, d=360 nm and n=1.44, d=410 nm for the hydrated P(60) and P(76) films, respectively. The results imply that the P(60) and P(76) films swell by 150% and 170%, respectively.

Resistance Change of Films

To fabricate a dual-mode PSS-b-PMB system, that is, a hygrometer that changes in color and resistance, AC impedance spectra of the films with regard to humidity were recorded using interdigitated gold elecrtrodes. Resistance values of the films were obtained from Nyquist impedance plots at high frequencies. Changes of the PSS-b-PMB sensors in resistance were monitored while relative humidity was stepwise changed as indicated by inverted arrows.

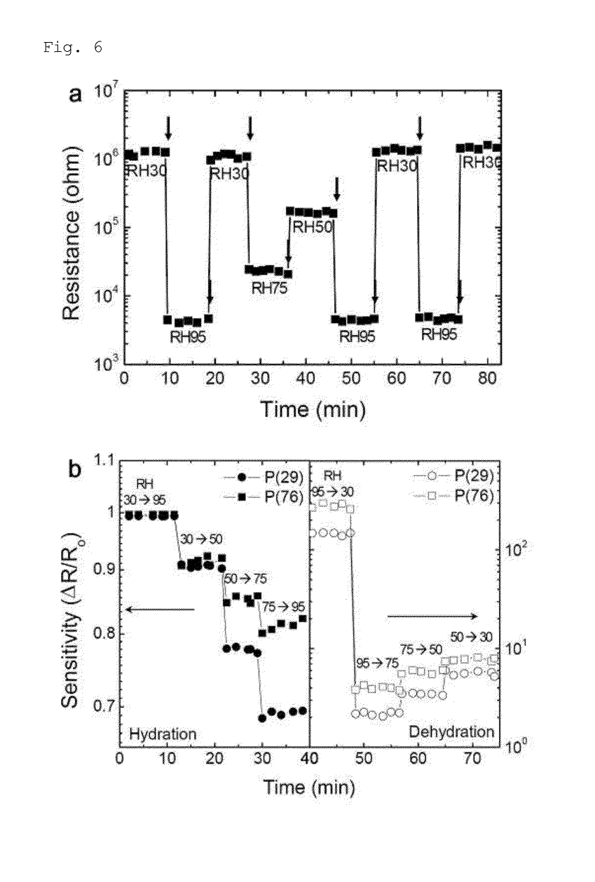

In FIG. 6a, representative results from the P(76) films are depicted. In dry air with RH 30%, the film was measured to have a resistance of 1.3×10⁶Ω while exposure to RH 95% reduced the resistance to 4.3×10³Ω, which is lower by 3 digits.

Resistivity changes occurred fast and reproducibly, irrespective of the degree of RH change. When RH was decreased from 95% to 30%, the resistance of the P(76) film was reverted to 1.3×10⁶Ω within one min. A stepwise change in RH from 30% to 75% causes a large reduction in resistivity from 1.3×10⁶Ω to 2.5×10⁴Ω. When secondarily exposed to RH 50%, the P(76) film had a resistance of 0.6×10⁵Ω, which was increased by one digit.

In FIG. 6b, two sensitive data sets of P(29) and P(76) films were plotted wherein the sensitivity is defined as ΔR/R₀ (ΔR: resistance change, R₀: initial resistance). During hydration, a large decrease in resistance at RH 95% made the sensitivity at RH 30% to 95% similar between the two samples. For different RH changes, the P(76) sensor exhibited a sensitivity of 0.8 or higher where as the sensitivity of P (29) was read at a relatively low point.

Peak sensitivities of P(29) and P(76) were read to be 150 and 280, respectively, when the RH drastically decreased from 95% to 30%. However, even when RH was changed a little from 50% to 30%, the sensitivities of P(29) and P(76) films were as high as 5.5 and 7.6, respectively. Like the color change, it took one min or less for the films to complete a resistance change.

Morphology Characterization

Cross-sectional morphologies of the PSS-b-PMB films were investigated by transmission electron microscope (TEM) experiments. Grazing incident small angle X-ray scattering (GISAXS) experiments were carried out at the beamline 3C, equipped with a charge-coupled device detector (2048×2048 pixels) at the Pohang Light Source (PLS). T he sample-to-detector distance was 2.76 m and the incident angle was varied from 0.10° to 0.24° in 0.01° increments.

Color Observation and Impedance Measurements.

The PSS-b-PMB films with a thickness of 240 nm were placed in a benchtop humidity/temperature environmental chamber (JEIO Tech, TH-PE-025). The changes in reflective color under levels of humidity were monitored in real-time via specially designed transparent window. The impedance of PSS-b-PMB films at each humidity condition was simultaneously measured using a 1260 Solatron impedance analyzer. For the impedance measurements, interdigitated gold stripes were employed as working and counter electrodes to apply a current to the films where the gold stripes were 300 μm wide and 300 μm apart. Data was obtained within a frequency range of 1˜100,000 Hz.

Optical Analysis:

Reflectance of PSS-b-PMB films coated on Si wafers was recorded at 25° C. using a Cary 5000 UV/vis/NIR spectrophotometer (Varian Inc.). The cuvette cell was modified for the humidity experiments. The cell contains salty water in its bottom and PSS-b-PMB films were located inside the cuvette using specially designed supporting mounts. UV Reflectance profiles of PSS-b-PMB films were then analyzed using a commercially available thin film optical program (Essential Macleod™ thin Film Center Inc.). Because of the scale difference, the intensity spectrum obtained from M by simulation was normalized by matching the maximum peak intensity to that obtained experimentally.

1. A colorimetric sensor, comprising a nano-film capable of absorbing a measurement target, formed on a reflection layer wherein the nano-film changes in color as its thickness changes with the absorption of the measurement target.

2. The colorimetric sensor of claim 1, wherein the measurement target is moisture.

3. The colorimetric sensor of claim 1, wherein the nano-film is a polymer thin fim.

4. The colorimetric sensor of claim 1, wherein the nano-film has a thickness of 10-400 nm.

5. The colorimetric sensor of claim 1, wherein the nano-film displays at least one color selected from the group consisting of violet, cyan, blue, green, yellow, orange, and red.

6. The colorimetric sensor of claim 1, wherein the nano-film changes in color toward longer wavelengths while thickening with the absorption of the measurement target.

7. The colorimetric sensor of claim 1, wherein the reflection layer is a light-reflecting substrate.

8. The colorimetric sensor of claim 1, wherein the nano-film absorbs the measurement target contained in gas.

9. The colorimetric sensor of claim 1, wherein the nano-film changes in thickness by up to 200%.

10. The colorimetric sensor of claim 1, wherein the nano-film changes in reflectance index with the absorption of the measurement target.

11. A chromogenic hygrometer, comprising an electrolyte polymer nano-film capable of absorbing moisture, formed on a reflection layer, wherein the nano-film changes in color and electrical resistivity as its thickness changes with the absorption of moisture.

12. The chromogenic hydrometer of claim 11, wherein the electrolyte polymer is a sulfonated polymer.

13. The chromogenic hydrometer of claim 11, wherein the electrolyte polymer is a block copolymer composed of a sulfonated polystyrene block and a hydrophobic block.

14. The chromogenic hydrometer of claim 11, wherein the electrolyte polymer is a sulfonated polystyrene-polyalkylbutylene block copolymer.

15. The chromogenic hydrometer of claim 11, wherein the electrolyte polymer has a morphology in which a cylindrical hydrophobic polymer is dispersed in an ordered fashion within a sulfonated polymer matrix.

16. A method for measuring humidity, using a hygrometer comprising an electrolyte polymer nano-film formed on a light-reflecting layer wherein the nano-film changes in color as its thickness varies with the absorption of moisture thereto.

17. The method of claim 16, wherein the electrolyte polymer film is further measured for a change in electric resistance.

18. The method of claim 16, wherein the color change is observed with a naked eye.

19. The method of claim 16, wherein the electrolyte polymer nano-film changes in thickness by up to 200% and in reflectance index by up to 10% with hydration.

20. The method of claim 16, wherein the electrolyte polymer nano-film changes in color toward longer wavelengths with an increase in relative humidity.

21. The method of claim 16, wherein the electrolyte polymer nano-film has a morphology in which cylindrical hydrophobic polymers are dispersed within an at least partially sulfonated polymer.

22. The method of claim 16, wherein the electrolyte polymer nano-film is composed of an at least partially sulfonated polystyrene-polyalkylbutyrene block copolymer.
